(19) United States
(12) Patent Application Publication
(10) Pub. No.: US 2007/0288591 A1
(43) Pub. Date: Dec. 13, 2007

(54) METHOD, SYSTEM, AND PROGRAM PRODUCT FOR CACHING APPLICATION DATA IN A BROWSER CACHE

(76) Inventors: HENRY Y. WONG, Cambridge, MA (US); CHARLES de SAINT-AIGNAN, Cambridge, MA (US); ROBERT YATES, Arlington, MA (US)

Correspondence Address: HOFFMAN, WARNICK & D'ALESSANDRO LLC, 75 STATE ST, 14TH FLOOR, ALBANY, NY, 12207, US

(21) Appl. No.: 11/423,737

(22) Filed: Jun. 13, 2006

(51) Int. Cl. G06F 15/16

(52) U.S. Cl. 709/217; 709/203

(57) ABSTRACT

The invention provides a method, system, and program product for caching application data in a browser cache. In one embodiment, a method according to the invention includes: providing to a web browser a uniform resource locator (URL) directed to application data; making a hypertext transfer protocol (HTTP) request using the URL; caching in the web browser cache the application data; determining whether the application data has changed since caching; in the case that the application data has changed since caching, providing to the web browser an updated URL directed to changed application data; and in the case that the application data has not changed since caching, using the cached application data.

### BACKGROUND OF THE INVENTION

1. Technical Field

The invention relates generally to data caching, and more particularly, to caching application data in a browser cache.

2. Background Art

Many web-based applications incorporate and/or use large amounts of application data. For example, a web-based email program may use data from the email application, typically stored on a remote server, as well as data from a separate address book application in order to display the names, email addresses, etc. of contacts as they would appear in the address book application. To do so, the web-based email program typically downloads data from both the email application and the address book application. However, data associated with the email application will change with every new message received, every message sent, and every message deleted by a user. In addition, data associated with the address book application are subject to periodic change and the particular subset of application data used by the web-based application at any given time is likely to change during a browser session. As a result, the web-based email application may be required to repeatedly download all of the data from the email program and the address book application in order to provide an accurate display.

For example, at the beginning of a browser session, the web-based email program's inbox may include 10 messages from six individuals. In addition to retrieving from the server the subject, size, and date received for each of the 10 messages, the web-based email program may also retrieve from the address book the preferred display name and/or format for each of the six senders. As the browser session continues, however, additional messages may be received in the user's inbox, including messages from other senders. In order to properly display the contents of the inbox, the web-based email program must download the message data (subject, date received, size, etc.) from the server and, if any of the messages are from new senders included in the address book application, the relevant address book data for each new sender.

Thus, a single browser session may require the repeated download of very large amounts of data, resulting in frequent and significant consumption of computer resources. In addition, once a browser session has ended, the email and downloaded address book data are discarded, requiring a new download upon the commencement of a new browser session.

One attempted solution to the problem of frequent downloads involves multiple hypertext transfer protocol (HTTP) requests to fetch information from a server. This is the approach taken by Google's web-based Gmail™ program. However, such HTTP requests are made only on an “as needed” basis to access data that are either not immediately needed by the browser or repeatedly refreshed. That is, the multiple HTTP request approach used by the Gmail™ program is not used to access application data, which are typically very large but relatively static compared to repeatedly-refreshed data.

Another approach involves the use of cookies to store data across browser sessions. However, the very small size limit of cookies, typically around 4 kilobytes, limits their usefulness in transferring and storing the large amounts of data typical of application data.

Yet another approach involves the use of asynchronous Javascript and XML (AJAX) to download data while a user is doing other things or to download data on an “as needed” basis. However, as with the multiple HTTP request approach above, this approach only works for data that are not needed immediately. In addition, the relevant data must be downloaded for every browser session.

To this extent, a need exists for a method for accessing application data in a web-based program that does not suffer from the defects described above.

### SUMMARY OF THE INVENTION

The invention provides a method, system, and program product for caching application data in a browser cache. In one embodiment, a method according to the invention includes: providing to a web browser a uniform resource locator (URL) directed to application data; making a hypertext transfer protocol (HTTP) request using the URL; caching in the web browser cache the application data; determining whether the application data has changed since caching; in the case that the application data has changed since caching, providing to the web browser an updated URL directed to changed application data; and in the case that the application data has not changed since caching, using the cached application data.

A first aspect of the invention provides a method for caching application data in a web browser cache, the method comprising: providing to a web browser a uniform resource locator (URL) directed to application data; making a hypertext transfer protocol (HTTP) request using the URL; and caching in the web browser cache the application data.

A second aspect of the invention provides a system for caching application data in a web browser cache, the system comprising: a system for providing to a web browser a uniform resource locator (URL) directed to application data; a system for making a hypertext transfer protocol (HTTP) request using the URL; and a system for caching in the web browser cache the application data.

A third aspect of the invention provides a program product stored on a computer-readable medium, which when executed, caches application data in a web browser cache, the program product comprising: program code for providing to a web browser a uniform resource locator (URL) directed to application data; program code for making a hypertext transfer protocol (HTTP) request using the URL; and program code for caching in the web browser cache the application data.

A fourth aspect of the invention provides a method for deploying an application for caching application data in a browser cache, comprising: providing a computer infrastructure being operable to: provide to a web browser a uniform resource locator (URL) directed to application data; make a hypertext transfer protocol (HTTP) request using the URL; and cache in the web browser cache the application data.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a flow diagram of an illustrative method according to the invention.

FIG. 2 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method, system, and program product for caching application data in a browser cache. The invention avoids the defects of known methods, such as those described above, by caching application data in a browser cache using multiple hypertext transfer protocol (HTTP) requests. In one embodiment, the invention includes caching application data in a browser cache, determining whether the application data has changed since last it was cached and, if so, providing to the browser a uniform resource locator (URL) directed to the changed application data, which may then be obtained by the browser via an HTTP request.

While the example described above involved the transfer and use of application data associated with email and address book applications, it should be recognized that the present invention is applicable to application data of any kind or associated with any type of application.

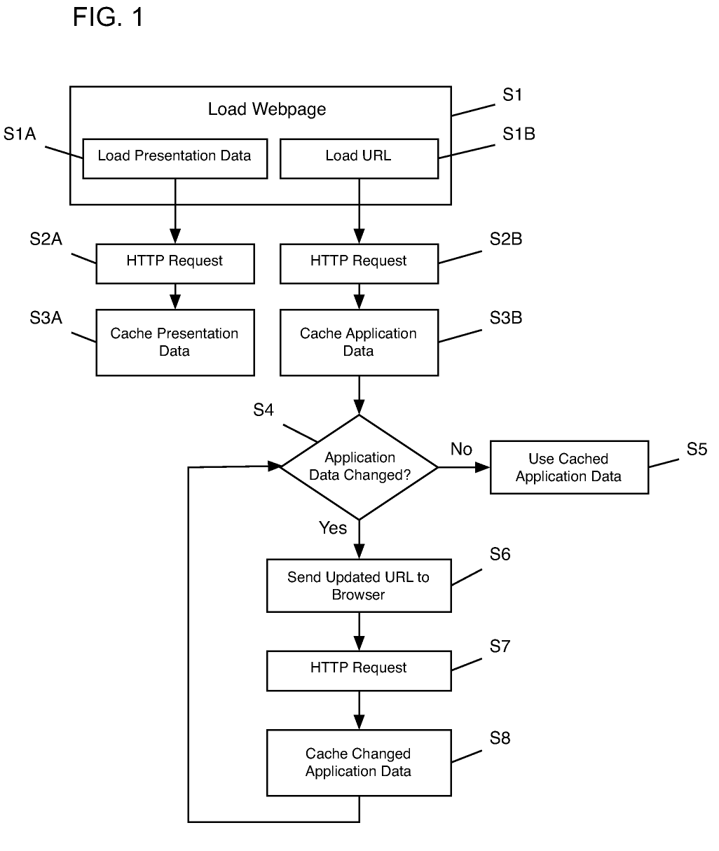

FIG. 1 shows a flow diagram of an illustrative method according to the invention. At step S1, a webpage is loaded by a browser. As is typical, this may include loading presentation data (e.g., hypertext markup language (HTML) data, images, etc.) at step S1A. Such presentation data is retrieved via an HTTP request at step S2A and cached in the browser cache at step S3A. However, unlike known methods, step S1 of the present invention also includes loading to the browser a uniform resource locator (URL) directed to application data at step S1B. As with the presentation data, an HTTP request is made at step S2B in order to retrieve the application data, which is then cached in the browser cache at step S3B.

Once stored in the browser cache, the browser may use the application data cached at step S3B. It is possible, however, that the application data have changed since being cached at step S3B. In known methods, a request would be made from the client side (e.g., the browser) to a server side component (e.g., a server), to determine whether the application data had changed. Typically, this would is done every time the application data, or portions thereof, are accessed. Thus, known methods require frequent client side queries in order to ensure that the most current application data are being used.

The present invention overcomes this difficulty by making a server side determination of whether the application data have changed at step S4. If not (i.e., No at step S4), the browser continues to use the cached application data at step S5. If, on the other hand, it is determined by the server side component that the application data have changed (i.e., Yes at step S4), an updated URL is sent to the browser at step S6, the updated URL being directed toward the changed application data. Once the updated URL is received by the browser, the changed application data are requested via an HTTP request at step S7 and cached in the browser cache at step S8. Steps S4 through S8 are thereafter iteratively looped in order to ensure that only the most recent application data are used by the web-based application.

Methods of the present invention greatly simplify the process of ensuring the use of current application data. For example, URLs directed toward application data may contain a timestamp (e.g., http://server/mailData_{—}06122006084532), which may be easily compared to a timestamp associated with the application data in order to determine whether the URL last transferred to the browser (and therefore the application data last cached in the browser cache) is directed to the most recent application data. Such a URL may be written, for example, using a JAVA™ (Sun Microsystems) server pages (JSP) tag within the webpage. The JSP tag may be delivered to the browser as part of the presentation data. Optionally, the server side component may maintain a log containing the timestamp of the application data most recently transferred to the browser, which is compared to the timestamp of the application data stored on the server. Regardless, it is a server side component that compares timestamps in order to determine whether the application data have changed since last transferred to the browser. Accordingly, rather than the client side component making queries to the server side each time application data are to be used, as in known methods, in the present invention, a client side component need only determine whether the URL is the same as the URL last used to transfer and cache the application data. If so, no communication with the server side is needed and the cached application data may be used (step S5). If, on the other hand, the URL is different than the URL last used to transfer and cache the application data, the client side component (e.g., browser) initiates a new HTTP request (step S7) in order to transfer and cache the changed application data (step S8).

Methods of the present invention, therefore, greatly reduce communications from client side components to server side components with respect to application data transferred therebetween, as compared to known methods. This is particularly advantageous when, as is often the case, the application data are large and relatively static.

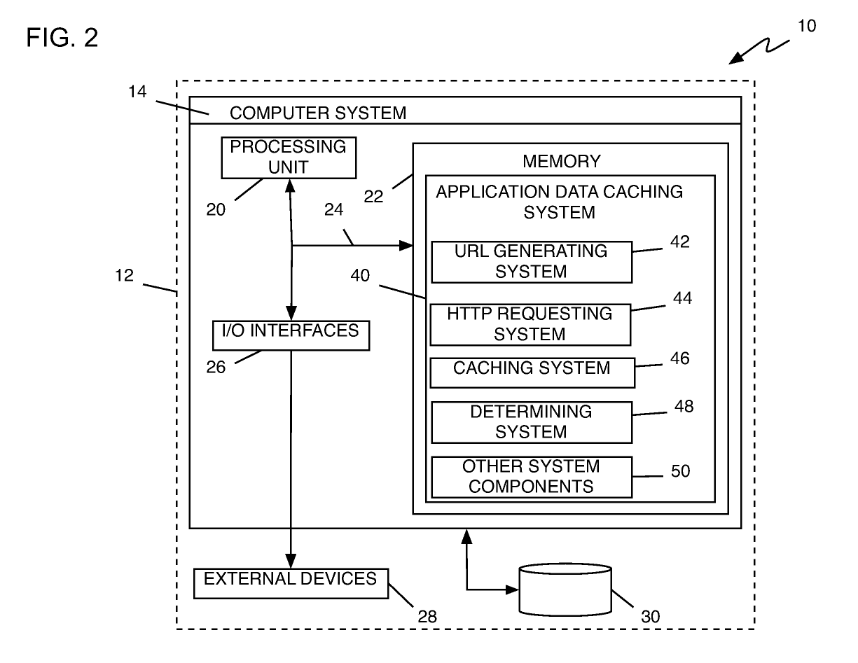

FIG. 2 shows an illustrative system 10 for caching application data in a browser cache. To this extent, system 10 includes a computer infrastructure 12 that can perform the various process steps described herein for caching application data in a browser cache. In particular, computer infrastructure 12 is shown including a computer system 14 that comprises an application data caching system 40, which enables computer system 14 to cache application data in a browser cache by performing the process steps of the invention.

Computer system 14 is shown including a processing unit 20, a memory 22, an input/output (I/O) interface 26, and a bus 24. Further, computer system 14 is shown in communication with external devices 28 and a storage system 30. As is known in the art, in general, processing unit 20 executes computer program code, such as application data caching system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and application data caching system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, application data caching system 40 enables computer system 14 to cache application data in a browser cache. To this extent, application data caching system 40 is shown including a URL generating system 42, an HTTP requesting system 44, a caching system 46, and a determining system 48. Operation of each of these systems is discussed above. Application data caching system 40 may further include other system components 50 to provide additional or improved functionality to application data caching system 40. It is understood that some of the various systems shown in FIG. 2 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for caching application data in a browser cache, it is understood that the invention further provides various alternative embodiments. For example, in one embodiment, the invention provides a computer-readable medium that includes computer program code to enable a computer infrastructure to cache application data in a browser cache. To this extent, the computer-readable medium includes program code, such as application data caching system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to cache application data in a browser cache as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for caching application data in a browser cache. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for caching application data in a web browser cache, the method comprising:
providing to a web browser a uniform resource locator (URL) directed to application data;
making a hypertext transfer protocol (HTTP) request using the URL; and
caching in the web browser cache the application data.

2. The method of claim 1, wherein the URL is provided by a server.

3. The method of claim 1, further comprising:
determining whether the application data has changed since caching; and
in the case that the application data has changed since caching, providing to the web browser an updated URL directed to changed application data.

4. The method of claim 3, wherein determining and providing are performed by a server.

5. The method of claim 3, wherein determining includes comparing a timestamp of the URL to a timestamp of the application data.

6. The method of claim 3, further comprising:
making an HTTP request using the updated URL; and
caching in the web browser cache the changed application data.

7. The method of claim 3, further comprising:
in the case that the application data has not changed since caching, using the cached application data.

8. The method of claim 1, wherein providing includes writing the URL using a JAVA server page (JSP) tag.

9. A system for caching application data in a web browser cache, the system comprising:
a system for providing to a web browser a uniform resource locator (URL) directed to application data;
a system for making a hypertext transfer protocol (HTTP) request using the URL; and
a system for caching in the web browser cache the application data.

10. The system of claim 9, further comprising:
a system for determining whether the application data has changed since caching; and
a system for providing to the web browser an updated URL directed to changed application data.

11. The system of claim 10, wherein the system for determining includes a system for comparing a timestamp of the URL to a timestamp of the application data.

12. The system of claim 10, further comprising:
a system for making an HTTP request using the updated URL; and
a system for caching in the web browser cache the changed application data.

13. The system of claim 10, further comprising:
a system for using the cached application data.

14. The system of claim 9, wherein the system for providing includes a system for writing the URL using a JAVA server page (JSP) tag.

15. A program product stored on a computer-readable medium, which when executed, caches application data in a web browser cache, the program product comprising:
program code for providing to a web browser a uniform resource locator (URL) directed to application data;
program code for making a hypertext transfer protocol (HTTP) request using the URL; and
program code for caching in the web browser cache the application data.

16. The program product of claim 15, further comprising:
program code for determining whether the application data has changed since caching; and
program code for providing to the web browser an updated URL directed to changed application data.

17. The program product of claim 16, wherein the program code for determining includes program code for comparing a timestamp of the URL to a timestamp of the application data.

18. The program product of claim 16, further comprising:
program code for making an HTTP request using the updated URL; and
program code for caching in the web browser cache the changed application data.

19. A method for deploying an application for caching application data in a browser cache, comprising:
providing a computer infrastructure being operable to:
provide to a web browser a uniform resource locator (URL) directed to application data;
make a hypertext transfer protocol (HTTP) request using the URL; and
cache in the web browser cache the application data.

20. The method of claim 19, further comprising:
providing a computer infrastructure being operable to:
determine whether the application data has changed since caching; and
in the case that the application data has changed since caching, provide to the web browser an updated URL directed to changed application data.
